(19) United States
(12) Patent Application Publication
(10) Pub. No.: US 2024/0385363 A1
(43) Pub. Date: Nov. 21, 2024

(54) BACKLIGHT MODULE AND DISPLAY DEVICE

(71) Applicant: Coretronic Corporation, Hsin-Chu (TW)

(72) Inventors: Chao-Hung Weng, Hsin-Chu (TW); Kuan-Wen Liu, Hsin-Chu (TW); Hao-Jan Kuo, Hsin-Chu (TW); Ming-Dah Liu, Hsin-Chu (TW)

(73) Assignee: Coretronic Corporation, Hsin-Chu (TW)

(21) Appl. No.: 18/660,208

(22) Filed: May 9, 2024

(30) Foreign Application Priority Data
May 15, 2023 (CN) 202321151915.3

(51) Int. Cl. F21V 8/00

(52) U.S. Cl. CPC G02B 6/0053; G02B 6/0051

(57) ABSTRACT

A backlight module, including a light guide element, a light source, and first and second optical elements, is provided. The first optical element is disposed on a side of a light exit surface of the light guide element. The first optical element includes first prism structures, each including a first base angle and a second base angle away from the light incident surface relative to the first base angle. The first base angle is different from the second base angle. The second optical element is disposed on a side of the light exit surface. The first optical element is located between the light guide element and the second optical element. The second optical element includes second prism structures, each including a third base angle and a fourth base angle away from the light incident surface relative to the third base angle. A display device is also provided.

### CROSS-REFERENCE TO RELATED APPLICATION

This application claims the priority benefit of China application serial no. 202321151915.3, filed on May 15, 2023. The entirety of the above-mentioned patent application is hereby incorporated by reference herein and made a part of this specification.

### BACKGROUND

### Technical Field

The disclosure relates to a light emitting module and an optical device, and in particular to a backlight module and a display device.

### Description of Related Art

The liquid crystal display includes a liquid crystal display panel. Since the liquid crystal display panel itself does not have the ability to emit light, the liquid crystal display panel must rely on a backlight module to provide a surface light source to the liquid crystal display panel, so that the user can watch an image displayed on the liquid crystal display panel. In the prior art, the backlight module mainly uses a light emitting diode as the surface light source, but the optical effects are limited. At present, after light rays pass through a lower diffuser sheet, the light rays are scattered toward multiple directions. Since the role of the diffuser sheet is to provide a uniform light source, the viewing angle is widened and the light radiation area is increased, thereby reducing the light intensity per unit area, that is, reducing the luminance. Therefore, in order to increase the light intensity of the backlight module, a prism sheet is required to converge the scattered light to a direct perpendicular to the panel again.

However, with such a module structure, the light rays can only be controlled to emit light within a range of 50 degrees of the full width at half maximum (FWHM) of the viewing angle. If the backlight module is used with the lower diffuser sheet, the viewing angles in the horizontal and vertical directions will have larger full width at half maximum, that is, wider viewing angles. Therefore, when a display needs to be applied with higher privacy and anti-peeping requirements, the backlight module must provide a narrower viewing angle in order to meet the requirements of a product. Therefore, how to use an optical film to adjust the full width at half maximum of the viewing angle, so as to improve the collimation of the backlight module and increase the luminance gain, so that the viewing angle of the module can meet the requirements of the end product is the main issue to be handled in the disclosure.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a backlight module, which includes a light guide element, a light source, a first optical element, and a second optical element. The light guide element has a light incident surface and a light exit surface perpendicular to each other. The light source is disposed on the light incident surface of the light guide element. The first optical element is disposed on a side of the light exit surface. The first optical element includes multiple first prism structures arranged along a first direction and extending along a second direction. Each first prism structure includes a first base angle and a second base angle away from the light incident surface relative to the first base angle. An angle of the first base angle is different from an angle of the second base angle. The second optical element is disposed on a side of the light exit surface. The first optical element is located between the light guide element and the second optical element. The second optical element includes multiple second prism structures arranged along the first direction and extending along the second direction. Each second prism structure includes a third base angle and a fourth base angle away from the light incident surface relative to the third base angle. An angle of the third base angle is different from an angle of the fourth base angle. The first direction is perpendicular to the second direction, and the second prism structure is located on a side of the second optical element away from the light guide element.

The disclosure provides a display device, which includes a backlight module and a display module. The backlight module is used to provide an illumination beam. The backlight module includes a light guide element, a light source, a first optical element, and a second optical element. The light guide element has a light incident surface and a light exit surface perpendicular to each other. The light source is disposed on the light incident surface of the light guide element. The first optical element is disposed on a side of the light exit surface. The first optical element includes multiple first prism structures arranged along a first direction and extending along a second direction. Each first prism structure includes a first base angle and a second base angle away from the light incident surface relative to the first base angle. An angle of the first base angle is different from an angle of the second base angle. The second optical element is disposed on a side of the light exit surface. The first optical element is located between the light guide element and the second optical element. The second optical element includes multiple second prism structures arranged along the first direction and extending along the second direction. Each second prism structure includes a third base angle and a fourth base angle away from the light incident surface relative to the third base angle. An angle of the third base angle is different from an angle of the fourth base angle. The first direction is perpendicular to the second direction, and the second prism structure is located on a side of the second optical element away from the light guide element. The display module is disposed on a transmission path of the illumination beam.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display device according to an embodiment of the disclosure.

FIG. 2 is a schematic diagram of a backlight module according to an embodiment of the disclosure.

FIG. 3 is a schematic diagram of a first optical element and a second optical element according to an embodiment of the disclosure.

FIG. 4 is a schematic diagram of a first optical element and a second optical element according to another embodiment of the disclosure.

FIG. 5 is a schematic diagram of a first optical element and a second optical element according to another embodiment of the disclosure.

FIG. 6 is a schematic diagram of a first optical element according to another embodiment of the disclosure.

FIG. 7 is a schematic diagram of a first optical element according to another embodiment of the disclosure.

FIG. 8 is a schematic diagram of a first optical element according to another embodiment of the disclosure.

FIG. 9 is a schematic diagram of a backlight module according to another embodiment of the disclosure.

FIG. 10 is a schematic diagram of a backlight module according to another embodiment of the disclosure.

FIG. 11 is a schematic diagram of a backlight module according to another embodiment of the disclosure.

FIG. 12 is a schematic diagram of a backlight module according to another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

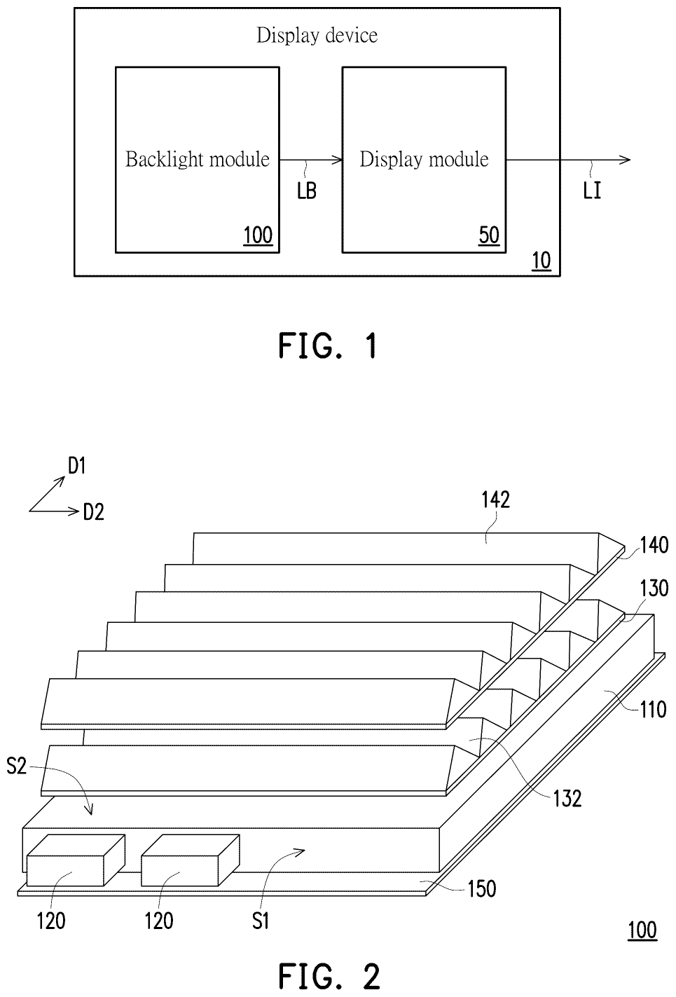

FIG. 1 is a schematic diagram of a display device according to an embodiment of the disclosure. Please refer to FIG. 1. This embodiment provides a display device 10 including a backlight module 100 and a display module 50. The backlight module 100 is configured to provide an illumination beam LB, and the display module 50 is disposed on a transmission path of the illumination beam LB and is configured to convert the illumination beam LB into an image beam LI and to provide the image beam LI out of the display device 10. The display module 50 is, for example, a liquid crystal display module.

FIG. 2 is a schematic diagram of a backlight module according to an embodiment of the disclosure. The backlight module 100 shown in this embodiment may at least be applied to the display device 10 shown in FIG. 1, which will be used as an example below. Please refer to FIG. 2. In this embodiment, the backlight module 100 includes a light guide element 110, a light source 120, a first optical element 130, and a second optical element 140. The light guide element 110 has a light incident surface S1 and a light exit surface S2 perpendicular to each other, and the light source 120 is disposed on the light incident surface S1 of the light guide element 110. The light guide element 110 is, for example, a light guide plate, the shape thereof may be flat or wedge-shaped, and the disclosure is not limited thereto. In addition, the light guide element 110 may have an optical microstructure (not shown in the drawing), wherein the optical microstructure is at least disposed on at least one of the light exit surface S2 of the light guide element 110 and a bottom surface (not labelled in the drawing) opposite to the light exit surface S2, wherein the optical microstructure may be formed through laser dotting, rolling, injection, etc., wherein the optical microstructure may be dotted in the form of partial dots or through grooves to increase the optical effects, the optical microstructure may be a concave structure or a convex structure, and the disclosure is not limited thereto. The same type or different types of optical microstructures may be selectively matched for the optical microstructures on the light exit surface S2 and the bottom surface of the light guide element 110. The light source 120 includes at least one light emitting unit, such as a light emitting diode (LED), but the disclosure is not limited thereto. In this embodiment, the backlight module 100 further includes a reflection element 150, which is disposed on the other side of the light guide element 110 opposite to the light exit surface S2 and is configured to reflect a light beam from the light guide element 110, thereby improving the usage efficiency of the light beam.

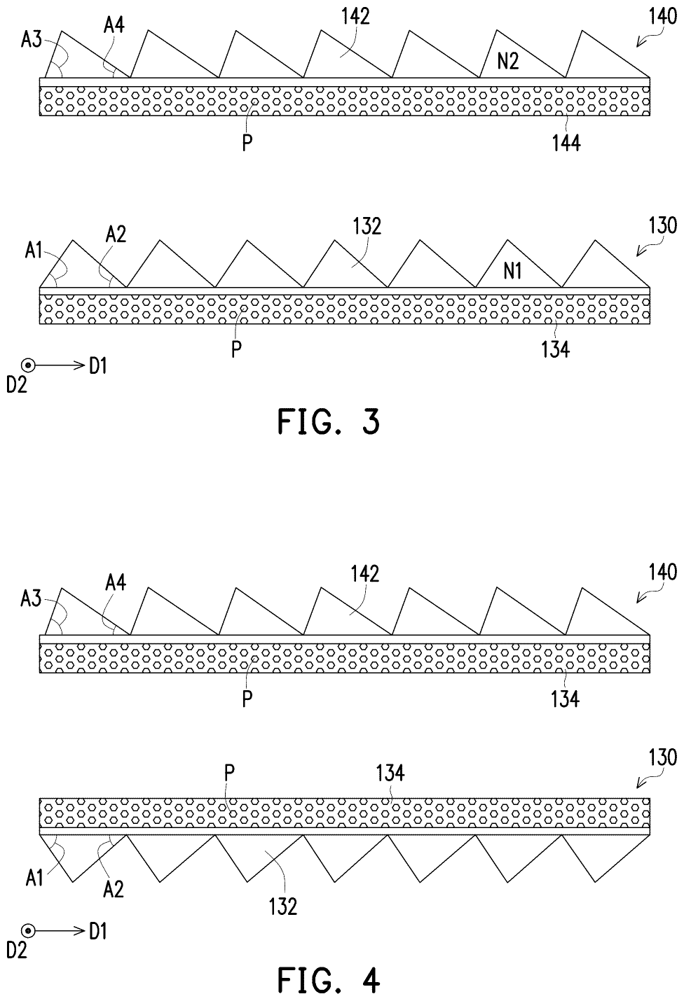

FIG. 3 is a schematic diagram of a first optical element and a second optical element according to an embodiment of the disclosure. Please refer to FIG. 2 and FIG. 3 at the same time, wherein FIG. 3 omits to show the light guide element 110 and the light source 120. The first optical element 130 is disposed on a side of the light exit surface S2. The first optical element 130 includes multiple first prism structures 132 arranged along a first direction D1 and extending along a second direction D2. Each of the first prism structures 132 includes a first base angle A1 and a second base angle A2 away from the light incident surface S1 relative to the first base angle A1, and the angle of the first base angle A1 is different from the angle of the second base angle A2. Specifically, the first base angle A1 is located between the light incident surface S1 and the second base angle A2. The first direction D1 is perpendicular to the second direction D2. In other words, the first prism structures 132 are asymmetrical prism structures, so the first optical element 130 is an asymmetrical prism sheet. In this embodiment, the average pitch of the first prism structure 132 is greater than 0 μm and less than or equal to 200 μm.

The second optical element 140 is disposed on a side of the light exit surface S2, and the first optical element 130 is located between the light guide element 110 and the second optical element 140. The second optical element 140 includes multiple second prism structures 142 arranged along the first direction D1 and extending along the second direction D2. Each of the second prism structures 142 includes a third base angle A3 and a fourth base angle A4 away from the light incident surface S1 relative to the third base angle A3, and the angle of the third base angle A3 is different from the angle of the fourth base angle A4. Specifically, the third base angle A3 is located between the light incident surface S1 and the fourth base angle A4. In other words, the second prism structures 142 are asymmetrical structures, so the second optical element 140 is an asymmetrical prism sheet. In this embodiment, the average pitch of the second prism structure 142 is greater than 0 μm and less than or equal to 200 μm.

In this embodiment, an included angle between the first direction D1 and a normal vector of the light incident surface S1 is equal to 0 degrees. However, in different embodiments, the included angle between the first direction D1 and the normal vector of the light incident surface S1 may be designed to be greater than 0 degrees and less than or equal to 50 degrees, so as to prevent the first prism structures 132 of the first optical element 130 and the second prism structures 142 of the second optical elements 140 from interacting with other optical elements in the backlight module 100 to generate interference fringes, wherein an included angle between the first prism structure 132 and the normal vector of the light incident surface S1 may be the same as an included angle between the second prism structure 142 and the normal vector of the light incident surface S1. In another embodiment, the included angle between the first prism structure 132 and the normal vector of the light incident surface S1 may be different from the included angle between the second prism structure 142 and the normal vector of the light incident surface S1.

In this embodiment, the optical effects are preferred when a refractive index N1 of the forming material of the first prism structure 132 is less than a refractive index N2 of the forming material of the second prism structure 142. In addition, in this embodiment, the haze of at least one of the first optical element 130 and the second optical element 140 is greater than 0% and less than or equal to 90%. Specifically, diffusion particles may be disposed in the first prism structure 132 of the first optical element 130 and/or the second prism structure 142 of the second optical element 140, and/or a diffusion layer 134/144 may be disposed on a side away from the first prism structure 132 and/or the second prism structure 142. In this embodiment, the diffusion layer 134/144 has a diffusion particle P. In other embodiments, the diffusion layer 134/144 may not have a diffusion particle, but have a roughened surface. In other embodiments, the diffusion layer 134/144 may have both a diffusion particle and a roughened surface, but the disclosure is not limited thereto.

In this embodiment, the first prism structure 132 is located on a side of the first optical element 130 away from the light guide element 110, and the second prism structure 142 is located on a side of the second optical element 140 away from the light guide element 110. However, in different embodiments, the first prism structure 132 may be located on a side of the first optical element 130 facing the light guide element 110, as shown in FIG. 4, and the disclosure is not limited thereto.

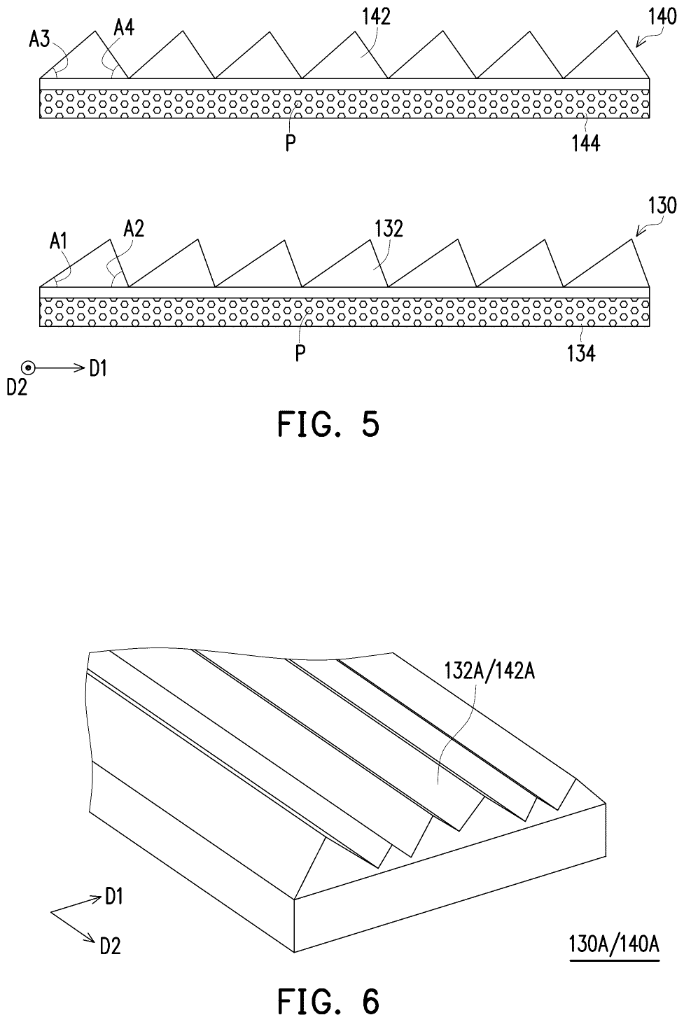

In detail, in this embodiment, the angle of the first base angle A1 of the first prism structure 132 is less than the angle of the third base angle A3 of the second prism structure 142. In addition, the angle of the first base angle A1 of the first prism structure 132 is greater than the angle of the second base angle A2, and/or the angle of the third base angle A3 of the second prism structure 142 is greater than the angle of the fourth base angle A4. However, in different embodiments, the angle of the first base angle A1 of the first prism structure 132 may also be designed to be less than the angle of the second base angle A2, and/or the angle of the third base angle A3 of the second prism structure 142 may also be designed to be less than the angle of the fourth base angle A4, as shown in FIG. 5.

In this way, through the optical design of the first optical element 130 with an asymmetrical prism and the second optical element 140 with an asymmetrical prism, the luminance of the backlight module 100 can be effectively improved and the backlight module 100 can have preferable optical effects. For example, in an embodiment, when the angles of the first base angle A1 and the second base angle A2 of the first prism structures 132 in the first optical element 130 are respectively 50 degrees and 40 degrees, and the angles of the third base angle A3 and the fourth base angle A4 of the second prism structures 142 in the second optical element 140 are respectively 70 degrees and 50 degrees, the luminance gain of the backlight module 100 can reach 1.9 times that of the prior art. In addition, in this embodiment, the full width at half maximum (FWHM) of light output from the backlight module 100 perpendicular to the light incident surface S1 is less than 25 degrees. For example, in the foregoing embodiment, the full width at half maximum (FWHM) of a horizontal viewing angle of the backlight module 100 is 40 degrees, which is close to that of the prior art. However, the full width at half maximum (FWHM) of a vertical viewing angle is reduced to 19 degrees, thereby limiting the viewing angle in one dimension (that is, the vertical direction) to be applied in an anti-peeping display and a vehicle display. The light efficacy of the formed backlight module 100 can also be greatly improved, the luminance gain is increased by more than 90% compared with the prior art, and the energy consumption of the display device can be reduced. The vertical viewing angle may be defined as the viewing angle perpendicular to the light incident surface S1 in this embodiment, and the horizontal viewing angle may be defined as the viewing angle parallel to the light incident surface S1 and the light exit surface S2 in this embodiment.

FIG. 6 is a schematic diagram of a first optical element according to another embodiment of the disclosure. Please refer to FIG. 6. A first optical element 130A and a second optical element 140A of this embodiment may at least be applied to any of the foregoing embodiments. The difference from any of the foregoing embodiments is that in this embodiment, the pitches of multiple first prism structures 132A of the first optical element 130A are unequal, and the depth of the first prism structures 132A is not further limited. Similarly, the pitches of multiple second prism structures 142A of the second optical element 140A may also be unequal, and the depth of the second prism structure 142A is not further limited. In this way, a relatively uniform optical effect can be provided. In other embodiments, it is also acceptable that the pitches of the prism structures of one of the first optical element 130A and the second optical element 140A are unequal.

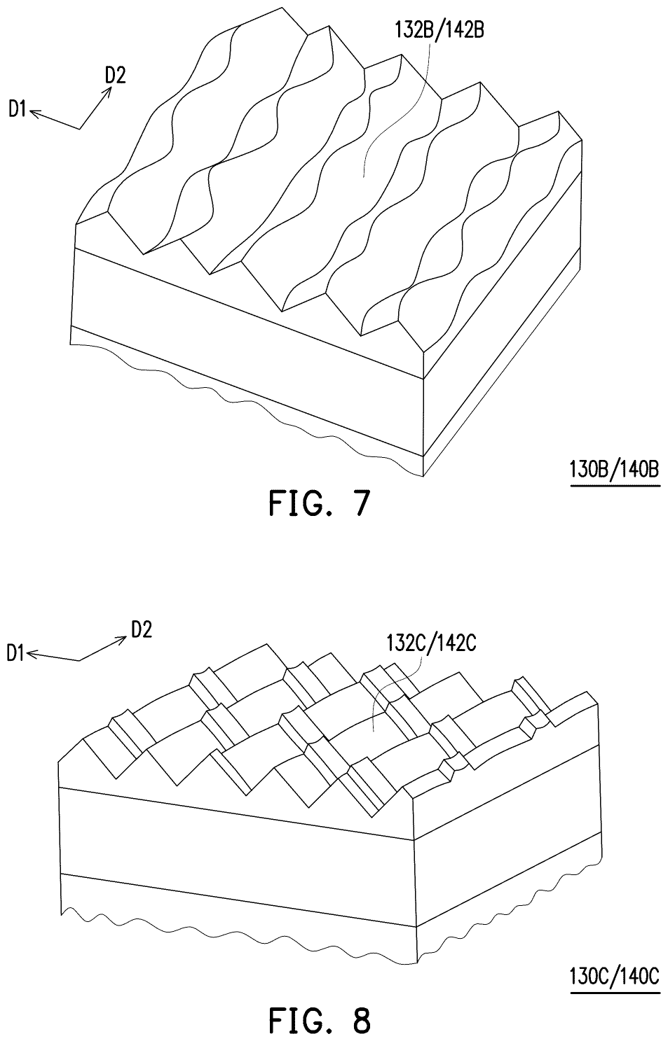

FIG. 7 is a schematic diagram of a first optical element according to another embodiment of the disclosure. Please refer to FIG. 7. A first optical element 130B and a second optical element 140B of this embodiment may at least be applied to any of the foregoing embodiments. The difference from any of the foregoing embodiments is that in this embodiment, the outlines of multiple first prism structures 132B of the first optical element 130B swing irregularly in the second direction D2 along the direction parallel to the first direction D1. Similarly, the outlines of multiple second prism structures 142B of the second optical element 140B swing irregularly in the second direction D2 along the direction parallel to the first direction D1. In this way, a relatively uniform optical effect can be provided, and interference can be prevented. In other embodiments, it is also acceptable that the outlines of the prism structures of one of the first optical element 130B and the second optical element 140B swing irregularly in the second direction D2 along the direction parallel to the first direction D1.

FIG. 8 is a schematic diagram of a first optical element according to another embodiment of the disclosure. Please refer to FIG. 8. A first optical element 130C and a second optical element 140C of this embodiment may at least be applied to any of the foregoing embodiments. The difference from any of the foregoing embodiments is that in this embodiment, the outlines of multiple first prism structures 132C of the first optical element 130C swing irregularly in the direction perpendicular to the first direction D1 and the second direction D2. Similarly, the outlines of multiple second prism structures 142C of the second optical element 140C swing irregularly in the direction perpendicular to the first direction D1 and the second direction D2. In this way, a relatively uniform optical effect can be provided, and interference can be prevented. In other embodiments, it is also acceptable that the outlines of the prism structures of one of the first optical element 130C and the second optical element 140C swing irregularly in the direction perpendicular to the first direction D1 and the second direction D2.

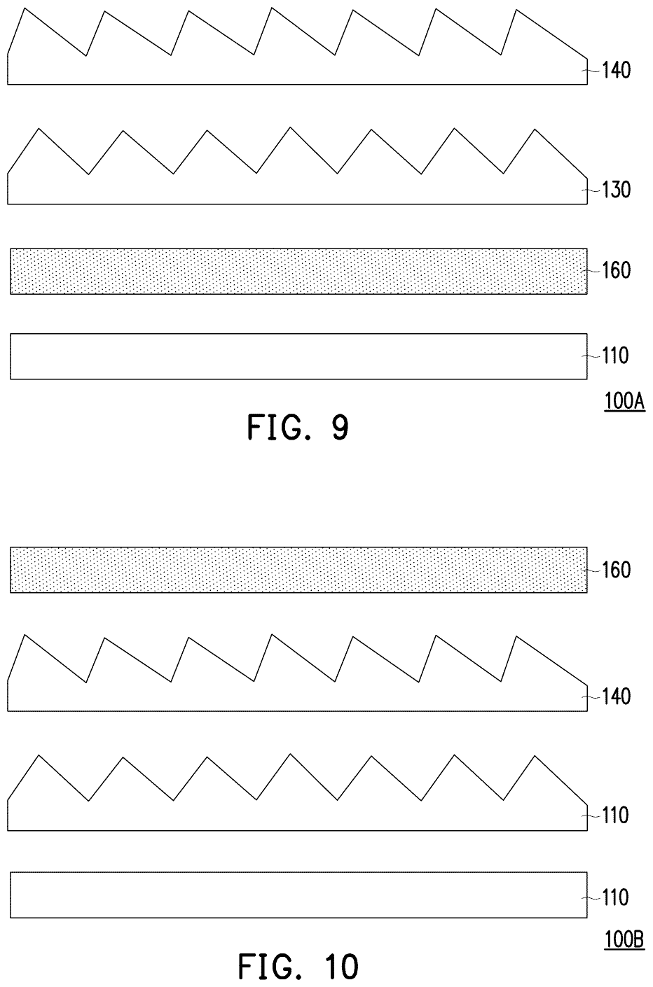

FIG. 9 is a schematic diagram of a backlight module according to another embodiment of the disclosure. Please refer to FIG. 9. A backlight module 100A of this embodiment is similar to the backlight module 100 shown in FIG. 2. The difference between them is that in this embodiment, the backlight module 100A further includes a first diffusion element 160 disposed between the first optical element 130 and the light guide element 110. The first diffusion element 160 is, for example, a diffuser sheet or other optical elements with a uniform light effect. In this way, a relatively uniform optical effect can be provided.

FIG. 10 is a schematic diagram of a backlight module according to another embodiment of the disclosure. Please refer to FIG. 10. A backlight module 100B of this embodiment is similar to the backlight module 100A shown in FIG. 9. The difference between the two is that in this embodiment, the first diffusion element 160 is disposed on a side of the second optical element 140 away from the light guide element 110. In this way, a relatively uniform optical effect can also be provided.

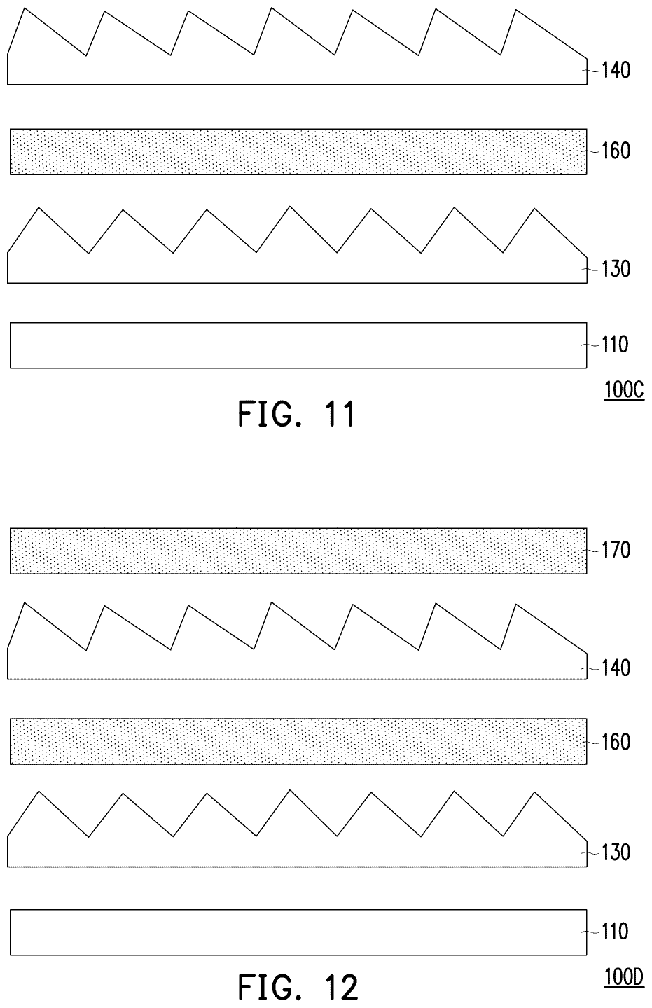

FIG. 11 is a schematic diagram of a backlight module according to another embodiment of the disclosure. Please refer to FIG. 11. A backlight module 100C of this embodiment is similar to the backlight module 100A shown in FIG. 9. The difference between the two is that in this embodiment, the first diffusion element 160 is disposed between the first optical element 130 and the second optical element 140. In this way, a relatively uniform optical effect can also be provided.

FIG. 12 is a schematic diagram of a backlight module according to another embodiment of the disclosure. Please refer to FIG. 12. A backlight module 100D of this embodiment is similar to the backlight module 100C shown in FIG. 11. The difference between the two is that in this embodiment, the backlight module 100D further includes a second diffusion element 170 disposed on a side of the second optical element 140 away from the light guide element 110. That is, in this embodiment, the backlight module 100D has an upper diffuser sheet and a lower diffuser sheet. In this embodiment, the second diffusion element 170 may be a diffuser sheet similar to the first diffusion element 160 or other optical elements with a uniform light effect or may be a dual brightness enhancement film. In this way, a relatively uniform optical effect can also be provided.

In summary, in the backlight module and the display device of the disclosure, the backlight module includes the light guide element, the light source, the first optical element, and the second optical element. The first optical element includes the first prism structures, and each first prism structure includes the first base angle and the second base angle away from the light incident surface relative to the first base angle, wherein the angle of the first base angle is different from the angle of the second base angle. The second optical element includes the second prism structures, and each second prism structure includes the third base angle and the fourth base angle away from the light incident surface relative to the third base angle, wherein the angle of the third base angle is different from the angle of the fourth base angle. In this way, through the optical design of the first optical element with the asymmetrical prism and the second optical element with the asymmetrical prism, the luminance of the backlight module can be effectively improved and the backlight module can have preferable optical effects.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a light guide element, having a light incident surface and a light exit surface perpendicular to each other;
a light source, disposed on the light incident surface of the light guide element;
a first optical element, disposed on a side of the light exit surface and comprising a plurality of first prism structures arranged along a first direction and extending along a second direction, wherein each of the plurality of first prism structures comprises a first base angle and a second base angle away from the light incident surface relative to the first base angle, and an angle of the first base angle is different from an angle of the second base angle; and
a second optical element, disposed on a side of the light exit surface, wherein the first optical element is located between the light guide element and the second optical element, the second optical element comprises a plurality of second prism structures arranged along the first direction and extending along the second direction, each of the plurality of second prism structures comprises a third base angle and a fourth base angle away from the light incident surface relative to the third base angle, and an angle of the third base angle is different from an angle of the fourth base angle, wherein the first direction is perpendicular to the second direction, and the plurality of second prism structures are located on a side of the second optical element away from the light guide element.

2. The backlight module according to claim 1, wherein the angle of the first base angle is less than the angle of the third base angle.

3. The backlight module according to claim 1, wherein the angle of the first base angle is greater than the angle of the second base angle.

4. The backlight module according to claim 1, wherein the angle of the third base angle is greater than the angle of the fourth base angle.

5. The backlight module according to claim 1, wherein a haze of at least one of the first optical element and the second optical element is greater than 0% and less than or equal to 90%.

6. The backlight module according to claim 1, wherein the plurality of first prism structures are located on a side of the first optical element away from the light guide element.

7. The backlight module according to claim 1, wherein the plurality of first prism structures are located on a side of the first optical element facing the light guide element.

8. The backlight module according to claim 1, wherein an included angle between the first direction and a normal vector of the light incident surface is greater than or equal to 0 degrees and less than or equal to 50 degrees.

9. The backlight module according to claim 1, wherein an average pitch of the plurality of first prism structures is greater than 0 μm and less than or equal to 200 μm.

10. The backlight module according to claim 1, wherein pitches of the plurality of first prism structures are unequal.

11. The backlight module according to claim 1, wherein outlines of the plurality of first prism structures swing irregularly in the second direction along a direction parallel to the first direction.

12. The backlight module according to claim 1, wherein outlines of the plurality of first prism structures swing irregularly in a direction perpendicular to the first direction and the second direction.

13. The backlight module according to claim 1, wherein a refractive index of the plurality of first prism structure is less than a refractive index of the plurality of second prism structure.

14. A backlight module according to claim 1, further comprising:
a first diffusion element, disposed between the first optical element and the light guide element or disposed on the side of the second optical element away from the light guide element.

15. A backlight module according to claim 1, further comprising:
a first diffusion element, disposed between the first optical element and the second optical element.

16. The backlight module according to claim 13, further comprising:
a second diffusion element, disposed on the side of the second optical element away from the light guide element.

17. The backlight module according to claim 1, wherein a full width at half maximum of light output from the backlight module is less than 25 degrees.

18. A display device, comprising:
a backlight module, configured to provide an illumination beam and comprising:
a light guide element, having a light incident surface and a light exit surface perpendicular to each other;
a light source, disposed on the light incident surface of the light guide element;
a first optical element, disposed on a side of the light exit surface and comprising a plurality of first prism structures arranged along a first direction and extending along a second direction, wherein each of the plurality of first prism structures comprises a first base angle and a second base angle away from the light incident surface relative to the first base angle, and an angle of the first base angle is different from an angle of the second base angle; and
a second optical element, disposed on a side of the light exit surface, wherein the first optical element is located between the light guide element and the second optical element, the second optical element comprises a plurality of second prism structures arranged along the first direction and extending along the second direction, each of the plurality of second prism structures comprises a third base angle and a fourth base angle away from the light incident surface relative to the third base angle, and an angle of the third base angle is different from an angle of the fourth base angle, wherein the first direction is perpendicular to the second direction, and the plurality of second prism structures are located on a side of the second optical element away from the light guide element; and
a display module, disposed on a transmission path of the illumination beam.
